(19) United States
(12) Patent Application Publication
(10) Pub. No.: US 2002/0066802 A1
(43) Pub. Date: Jun. 6, 2002

(54) Trigger spray and container provided with trigger spray

(76) Inventor: Tetsuya Tada, Tokyo (JP)

Correspondence Address: FLYNN, THIEL, BOUTELL & TANIS, P.C., 2026 Rambling Road, Kalamazoo, MI, 49008-1699, US

(21) Appl. No.: 09/755,319

(22) Filed: Jan. 5, 2001

(30) Foreign Application Priority Data
Dec. 5, 2000 (JP) 2000-370649

(51) Int. Cl. B05B 1/30

(52) U.S. Cl. 239/333; 239/354; 239/571

(57) ABSTRACT

A trigger spray having much smaller number of components and a spray container provided with this trigger spray. The trigger spray for injecting liquid in a container through a nozzle by pulling a trigger comprises a cap attached to an opening of the container, a base body supported by and fixed to the cap and having a first valve case, a secondary valve case, a cylinder in which a piston slides, a trigger movably mounted on the base body and connected to the piston for pressing the piston to compress liquid in the cylinder, a spring mounted between the trigger and the base body for elastically supporting the trigger relative to the base body, a cover and the nozzle engaged in and fixed to the base body, a primary valve inserted into the first valve case and a tube mounted in the first valve case, and a secondary valve 9 inserted into the secondary valve case and positioned between the nozzle and the secondary valve case.

### BACKGROUND OF THE INVENTION

1. Field of the Invention

The invention relates to a pump dispenser, more particularly to a trigger spray having a construction to compress liquid in a cylinder by a force generated when a trigger is turned, thereby injecting liquid through a nozzle.

2. Related Art

A spray container has been conventionally employed for spraying or injecting liquid such as chemical agents. A pump dispenser serving as an injecting mechanism attached to the spray container employs, for example, a trigger spray. The trigger spray has a construction such that a trigger having a wing-like shape is movably mounted on a base body wherein the trigger is pulled to operate a pump comprising a cylinder and a piston so that liquid in a container is injected outward through a nozzle owing to the compression force of the pump.

FIG. 9 shows more specifically an example of a conventional trigger spray.

As shown in FIG. 9, a trigger spray 100 comprises a cap 101 which is attached to an opening of a container body, a valve case 103 which is supported by and fixed to the opening of the container by way of a packing 102 when the cap 101 is screwed into the opening of the container and is provided with a primary valve 104, a tube 105 which is inserted in and fixed to the valve case 103, a housing 106 which is engaged with and fixed to the valve case 103, a plunger 109 which is provided with a piston 108 that slides in a cylinder formed in the base body, a trigger 110 for pressing the plunger 109, a spring 111 for elastically supporting the trigger 110 relative to the base body and a secondary valve 112 which is inserted into the valve case of the base body.

With the trigger spray having such a construction, the trigger 110 is pulled by fingers in an initial state where the cylinder is filled with liquid so as to inject liquid in the container body through the nozzle 107. As a result, the plunger 109 is pressed so that the piston 108 compresses liquid in the cylinder of the housing 106. The compressed liquid passes through a gap between the housing 106 and the valve case 103 which is inserted into the housing 106, then passes through the secondary valve 112, thereafter it is injected outward through the tip end of the nozzle.

When the fingers are released from the trigger 110, the trigger 110 is returned to an original state owing to an elastic force of the spring 111. At this time, liquid in the container body passes through the tube 105, the primary valve 104, and then the cylinder is filled with liquid, to the contrary to the foregoing, rendering liquid in the cylinder to be in the initial state.

The trigger spray having the foregoing construction is formed of twelve components in total, namely, the cap 101, the packing 102, the primary valve 104, the valve case 103, the tube 105, the housing 106, the nozzle 107, the piston 108, the plunger 109, the trigger 110, the spring 111 and the secondary valve 112.

Accordingly, the assembling process for manufacturing the trigger spray is complex, causing a problem that the number of steps of the procedure increases.

Further, it is necessary to decrease the number of components in view of the fact that that it is very important for the trigger spray having the foregoing construction to maintain liquid-tightness.

Still further, since the twelve components in total are gathered or collected in a small capacity of the trigger spray, it is preferable to decrease the number of components as much as possible so as to avoid a trouble of trigger spray.

### SUMMARY OF THE INVENTION

In view of the actual circumstances of the conventional trigger spray, it is an object of the invention to provide a trigger spray comprising the small number of components and a container provided with this trigger spray.

The inventor of this application endeavored himself to study the problems of the conventional trigger spray and have found measures to solve the foregoing problems by integrating components of a trigger spray as much as possible so that such components integrated with one another can sufficiently perform its function even in an assembled state based on which the invention has been completed.

To achieve the above objects, the trigger spray A for injecting liquid in a container through a nozzle by pulling a trigger 2 according to the first aspect of the invention is characterized in comprising a cap 7 attached to an opening B of the container, a base body 1 supported by and fixed to the cap 7 and having a first valve case 11, a secondary valve case 12, a cylinder 13 in which a piston 4 slides, a trigger 2 movably mounted on the base body 1 and connected to the piston 4 for pressing the piston 4 to compress liquid in the cylinder 13, a spring 3 mounted between the trigger 2 and the base body 1 for elastically supporting the trigger 2 relative to the base body 1, a cover 5 and the nozzle 6 engaged in and fixed to the base body 1, a primary valve 8 inserted into the first valve case 11 and a tube 10 mounted in the first valve case 11, and a secondary valve 9 inserted into the secondary valve case 12 and positioned between the nozzle 6 and the secondary valve case 12.

The trigger spray A according to the second aspect of the invention is characterized in that the nozzle 6 is integrated with and connected to the cover 5 by way of a thin thickness portion 4A serving as a hinge.

The trigger spray A according to the third aspect of the invention is characterized in that the spring 3 is integrated with the trigger 2.

The trigger spray A according to the fourth aspect of the invention is characterized in that the nozzle 6 is integrated with and connected to the cover 5 by way of a thin thickness portion 4A serving as a hinge, and the spring 3 is integrated with the trigger 2.

The trigger spray A according to the fifth aspect of the invention is characterized in that the nozzle 6 comprises a nozzle base 6A and a nozzle cap 6B which is engaged with the nozzle base 6A to be freely turned about the nozzle base 6A.

The trigger spray A according to the sixth aspect of the invention is characterized in that the base body 1 is sealed by an inner wall surface B1 and an upper wall surface B2 of the opening B of the container body.

The trigger spray A according to the seventh aspect of the invention is characterized in that the nozzle 6 comprises a nozzle base 6A and a two-way nozzle cap 6B which is attached to the nozzle base 6A, wherein two way nozzle cap BB comprises a forming cover member 6B 1 and which can be selectively set and a closable cover member.

The trigger spray A according to the eighth aspect of the invention is characterized in that the cover 5 is engaged with and connected to the base body 1 at two spots.

The trigger spray A according to the ninth aspect of the invention is characterized in that the cover 5 and the nozzle 6 are formed of a polyolefine based resin, and integrated with each other.

The trigger spray A according to the tenth aspect of the invention is characterized in that the trigger 2 and the spring 3 are formed of a polyolefine based resin, and integrated with each other.

The spray container according to the eleventh aspect of the invention is characterized in that it is provided with the trigger spray as set forth in the first aspect of the invention.

It is a matter of course to employ the construction formed of the combination of not less than two of the first to ninth aspects of the invention, if it can achieve the foregoing object of the invention, and it is also a matter of course to employ a spray container provided with such a trigger spray.

According to the first to tenth aspects of the invention, since the cover and the nozzle are integrated with each other and/or the trigger and the spring are integrated with each other, the number of assembling steps is reduced, and the trouble of the trigger spray is reduced and the trigger spray is excellent in liquid-tightness.

### BRIEF DESCRIPTION OF THE DRAWINGS

FIG. 1 is an external view of a trigger spray according to a first embodiment of the invention;

FIG. 2 is a sectional view showing the construction of the trigger spray according to the first embodiment of the invention;

FIG. 3 is an external view of a trigger;

FIG. 4 is a view showing a state where the trigger including a spring is attached to a base body;

FIG. 5 is a view showing a state where the trigger of the trigger spray is pulled;

FIG. 6(A) and FIG. 6(B) are perspective views showing attaching operation of the cover relative to the base body, wherein FIG. 6(A) shows a state where a nozzle is attached to the front portion of the base body and FIG. 6(B) shows a state where the cover is completely attached to the base body;

FIG. 7 is a sectional view of a trigger spray according to a second embodiment;

FIGS. 8(A) to 8(C) are sectional views showing the construction of a trigger spray according to the third embodiment of the invention; and

FIG. 9 is a sectional view showing the construction of a conventional trigger spray.

### PREFERRED EMBODIMENT OF THE INVENTION

First, second and third embodiments of the invention are now described with reference to the attached drawings.

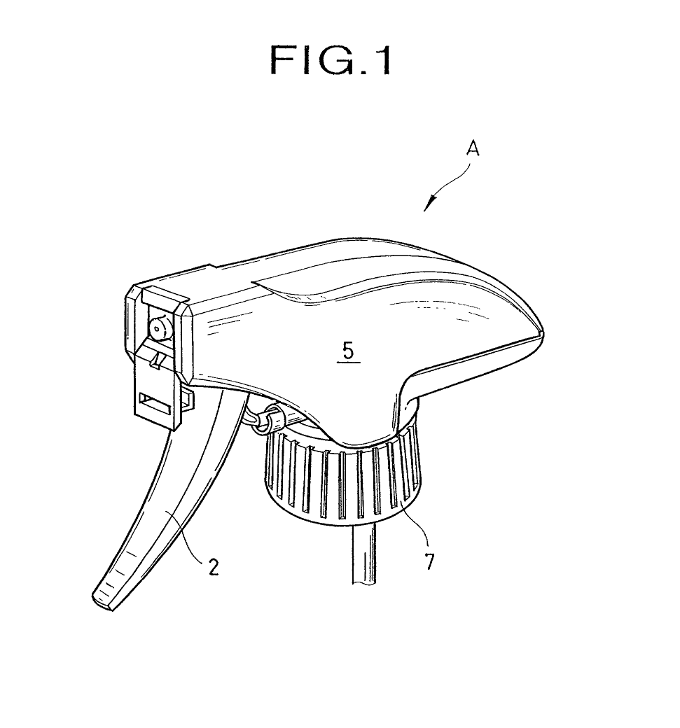

First Embodiment (FIGS. 1 to 6):

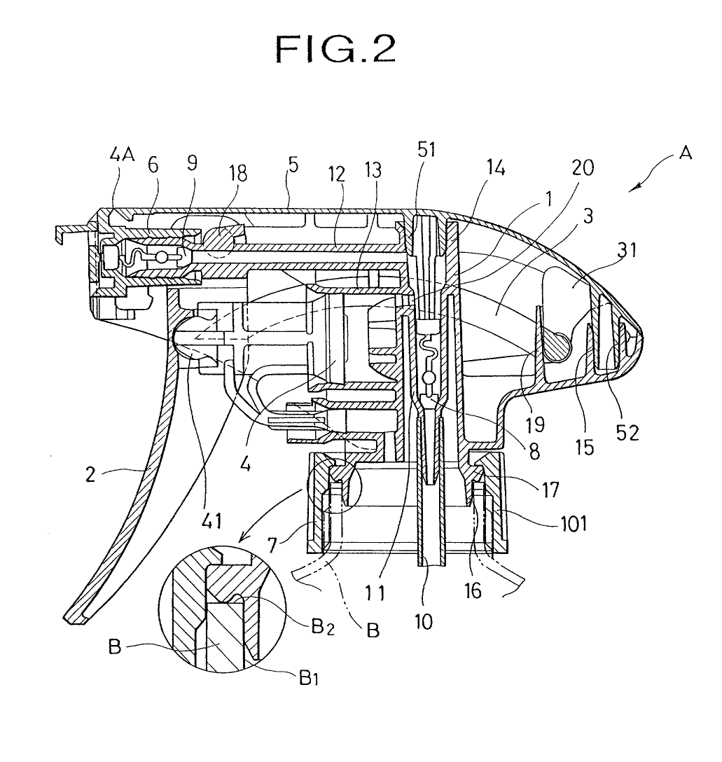

FIG. 1 is an external view showing a trigger spray A according to the first embodiment of the invention, and FIG. 2 is a sectional view of the construction of the trigger spray A in FIG. 1.

The trigger spray A has a construction that a trigger 2 is movably mounted on a base body 1 wherein the trigger 2 is pulled by fingers, liquid in a cylinder 13 forming a part of the base body 1 is compressed by a piston 4 so that liquid in a container can be injected outward through a nozzle 6.

That is, the trigger spray A comprises a cap 7 attached to an opening B of the container, the base body 1 supported by and fixed to the cap 7, a tube 10 mounted in a first valve case 11 forming a part of the base body 1, a primary valve inserted into the first valve case 11, a cover 5 and the nozzle 6 engaged in the base body 1, the piston 4 sliding in the cylinder 13 forming a part of the base body 1, the trigger 2 attached to the base body 1 for pressing the piston 4, a spring 3 for elastically supporting the trigger 2 relative to the base body 1, and a secondary valve 9 mounted between the nozzle 6 and the base body 1.

The construction of assembling these components of the trigger spray is described as follows.

The base body 1 is attached to a spray container body by the cap 7. When the cap 7 is screwed into the opening B of the container body, the base body 1 is fixed to the container body.

In this case, a lower end 16 and a flange 17 of the base body 1 are sealed by an inner wall surface B1 and an upper wall surface B2 of the opening B of the container body so that sealing property, i.e. liquid-tightness is guaranteed with assurance.

Particularly, since the lower end 16 of the base body 1 has a seal link shape, it is brought into intimate contact with the inner wall surface B1 of the opening B, thereby securing liquid-tightness.

Further, the base body 1 has the first valve case 11 formed in a vertical direction thereof and a secondary valve case 12 formed in a horizontal direction thereof, wherein the primary valve 8 is inserted into the first valve case 11, and the secondary valve 9 is inserted into the secondary valve case 12.

The tube 10 is engaged with the first valve case 11 and the tube 10 hangs downward inside the container body. Liquid inside the container body is sucked upward through the tube 10. The cover 5 and the nozzle 6 are engaged in and fixed to the base body 1.

The cover 5 has two fixing protrusions 51, 52 at the front and rear portions thereof wherein the front fixing protrusion 51 is attached to a front fixing receiver 14 formed on the extension line of the secondary valve case 12 and the rear fixing protrusion 52 is attached to a rear fixing receiver 15 formed on the rear portion of the base body 1.

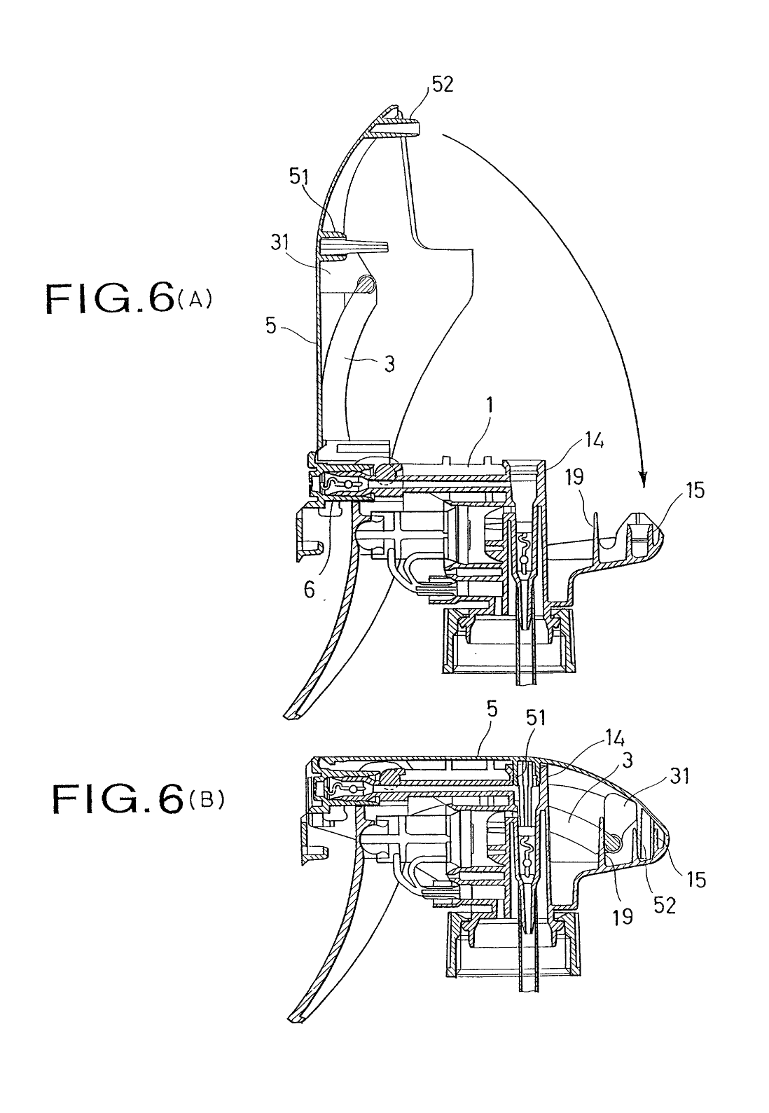

The nozzle 6 is connected to the tip end of the cover 5 by way of a thin thickness portion 4A serving as a hinge so that the cover 5 can be turned up and down about the thin thickness portion 4A (see FIG. 6). In this case, it is preferably that the cover 5 and the nozzle 6 are formed of a polyolefine based resin, for example, polypropylene and integrated with each other.

The cylinder 13 is formed in a part of the base body 1 and the piston 4 reciprocates or moves back and forth in the cylinder 13 while sliding in the inner wall thereof. The trigger 2 is attached to the base body 1 for pressing the piston 4. The trigger 2 has a wing-like shape so that fingers can be put thereon or caught thereby, and it is pivoted at the upper end thereof by a support pivot 18 formed in the base body 1 while the piston 4 is engaged with and fixed to the trigger 2 at the low end thereof. Accordingly, when the trigger 2 is pulled rightward in the figures while it is caught by fingers, a head 41 of the piston 4 is pressed so that the piston 4 slides in the cylinder 13.

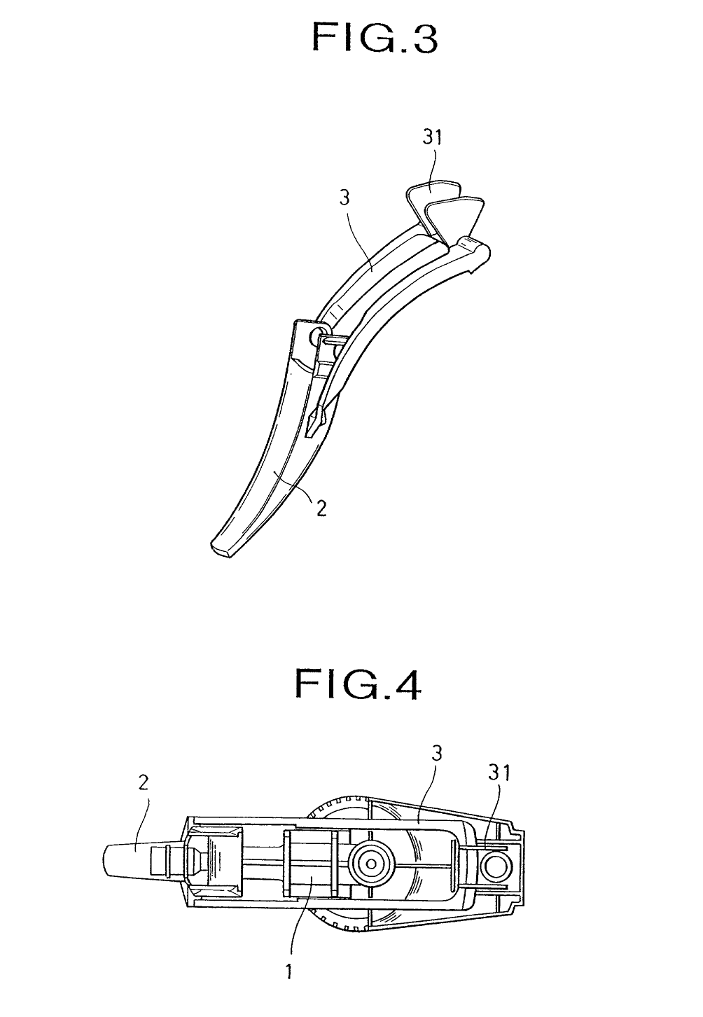

The spring 3 is integrally formed with the trigger 2, as shown in FIG. 3, and the trigger 2 pulled by the fingers can be returned to an original position with assurance owing to an elastic force of the spring 3 (particularly owing to an elasticity at the connecting portion between the spring 3 and the trigger 2).

FIG. 4 shows a state where the trigger 2 is attached to the base body 1. As evident from FIGS. 4 and 2, in a state where the trigger 2 is attached to the base body 1, one end base 31 of the spring 3 is rendered in a state where it is supported and fixed between a rear standing wall 19 of the base body 1 and the rear fixing protrusion 52 formed in the cover 5.

With the trigger spray having the foregoing construction, an operation for injecting liquid is described next.

Suppose that an initial state is a state where the cylinder 13 is filled with liquid. A back of the thumb is brought into contact with the opening B of the container body while other fingers are put on or caught by the trigger to pull the trigger strongly.

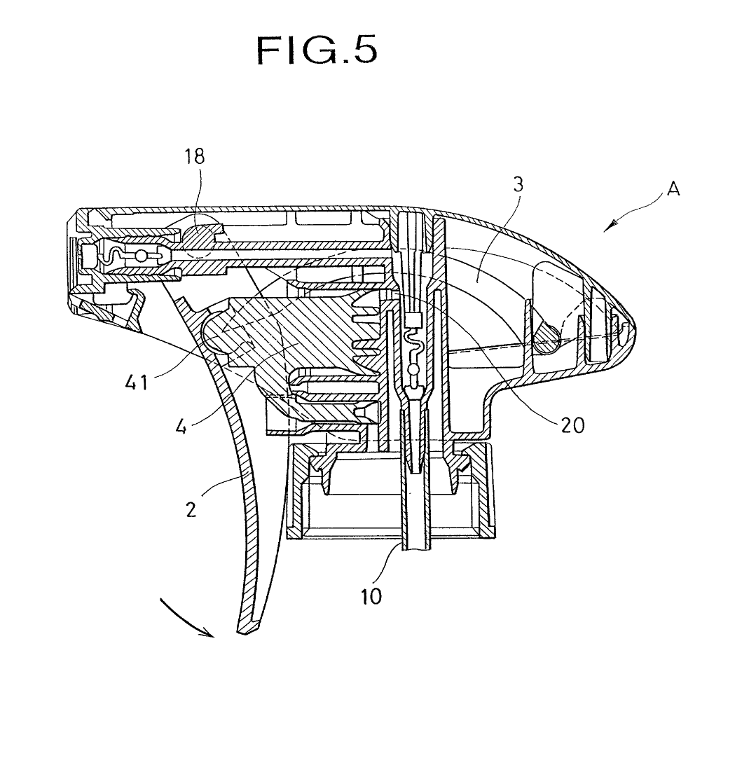

The pulled trigger 2 is turned about the support pivot 18 as a fulcrum to press the piston 4. The piston 4 is pressed by the trigger 2 to slide in the cylinder 13, thereby compressing liquid in the cylinder 13. The thus compressed liquid passes through an opening 20 and the secondary valve case 12, then it is injected through the tip end of the nozzle 6 (see FIG. 5).

When the fingers are released next from the trigger 2, the trigger 2 is returned to the initial state owing to the elastic force of the spring 3.

Since the piston 4 attached to the trigger 2 is also returned to the original position at this time, the cylinder 13 is negatively pressurized so that liquid in the container body passes through the tube 10 and the opening 20 so that the cylinder 13 is filled with liquid to the contrary.

Meanwhile, since the number of the trigger spray of the first embodiment of the invention is eight, and hence the components thereof are easily assembled.

The procedure for assembling the components of the trigger spray comprises the following steps.

1. firstly pressing the cap 7 into the base body 1 so that the former is mounted in the latter;

2. inserting the piston 4 into the cylinder 13 forming a part of the base body 1;

3. attaching the trigger 2 to the base body 1 while the trigger 2 is engaged with and attached to the piston 4. When the trigger 2 is attached to the base body 1, the spring 3 integrated with the trigger 2 is also attached to the base body 1;

4. inserting the primary valve 8 into the first valve case 11;

5. inserting the secondary valve 9 into the secondary valve case 12;

6. engaging the nozzle 6 with the secondary valve case 12 of the base body 1 (see FIG. 6(A));

7. turning the cover 5 connected to the nozzle 6 about the thin thickness portion 4A serving as a hinge so that the front fixing protrusion 51 and the rear fixing protrusion 52 are engaged in and attached to the front fixing receiver 14 and the rear fixing receiver 15 of the base body 1 (see FIG. 6(B)); and

8. finally engaging the tube 10 with and pressing the tube against the lower end of the first valve case 11 of the base body 1.

The assembly of the components of the trigger spray are completed with the foregoing procedure.

As mentioned above, the number of the components of the trigger spray of the first embodiment of the invention is less than that of the conventional trigger spray, and hence the trigger spray can be easily assembled.

Since the trigger 2 and the spring 3 are integrally formed with each other, any play is not produced between the spring 3 and the trigger 2 after the trigger spray is assembled.

Although the nozzle 6 receives a force to break or move away from the secondary valve case 12 when liquid is injected, such a force is weakened because the nozzle 6 is integrally formed with the base body 1 according to the first embodiment of the invention.

Although the cover 5 is engaged with and fixed to the base body 1 at two spots, i.e. at the front fixing protrusion 51 and the rear fixing protrusion 52, the cover 5 receives a force to detach or move away from the base body 1 by the liquid force of the base body 1, particularly, at the front fixing protrusion 51.

However, since the cover 5 is connected to the nozzle 6 about the thin thickness 4A serving as the hinge, the cover 5 is hardly detached from the base body 1 since a divided force operates in the direction inclined from a directly detaching or unhinged direction.

Meanwhile, although the spring 3 in the trigger spray has been formed of polyacetal resin so that the components of the trigger spray are neatly housed in the trigger spray without being leaned after the trigger spray was assembled according to the conventional trigger spray, the spring 3 can be formed of polypropylene so as to secure the stability of the assembly of the trigger spray by integrating the trigger 2 with the spring 3 according to the first embodiment of the invention.

Since liquid-tightness of the base body 1 relative to the opening B of the container body is secured with the construction of the base body 1 peculiar to the lower end thereof, it was not necessary to employ an independent or separate packing (normally formed of ethylene vinyl acetate polymer).

With the foregoing construction of the trigger spray of the first embodiment of the invention, the primary valve 8, and the secondary valve 9 and the piston 4 can be formed of polyethylene resin and the components other than these components can be formed of polypropylene resin, and hence the trigger spray can be formed of a so-called polyolefine based resin, which can be recycled.

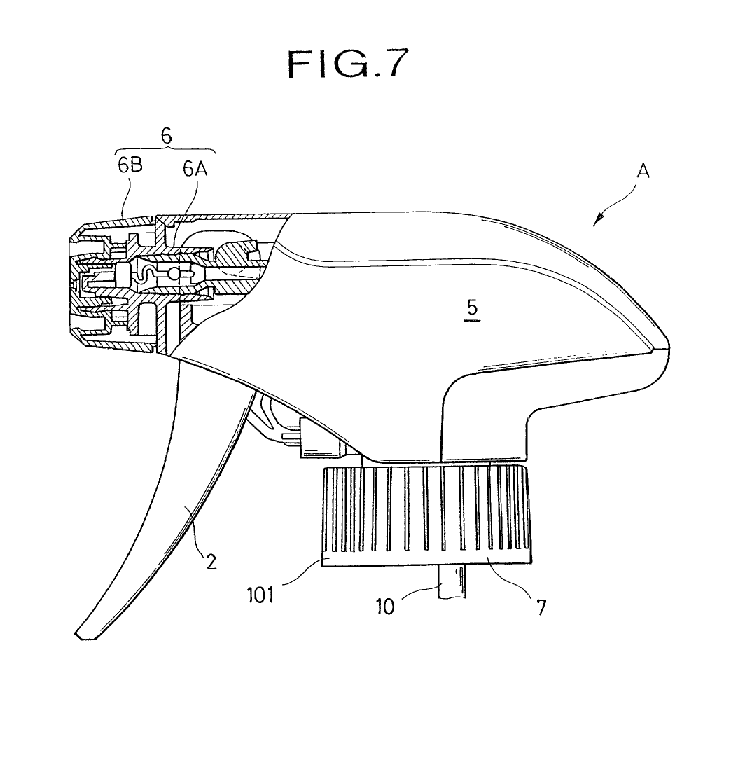

Second Embodiment (FIG. 7):

A trigger spray according to a second embodiment of the invention is now described with reference to FIG. 7.

The trigger spray according to the second embodiment of the invention is the same as the trigger spray of the first embodiment of the invention except a nozzle 6.

The nozzle 6 of the second embodiment of the invention comprises a nozzle base 6A and a nozzle cap 6B which is engaged with and fixed to the nozzle base 6A to be freely turned about the nozzle base 6A.

When the nozzle cap 6B is turned, the nozzle 6 is opened or closed.

In the second embodiment of the invention, the number of the components of the trigger spray becomes nine which increases by one component compared with the number of those of the first embodiment but decreases compared with the number of those of the conventional trigger spray. Accordingly, the trigger spray of the second embodiment of the invention is excellent in the number of steps of assembling process of the components of the trigger spray, reduction of a trouble of the trigger spray and liquid-tightness of the trigger spray.

Still further, since the nozzle cap 6B is formed of polypropylene resin, it can be recycled like the first embodiment of the invention and also can cope with an environmental problem.

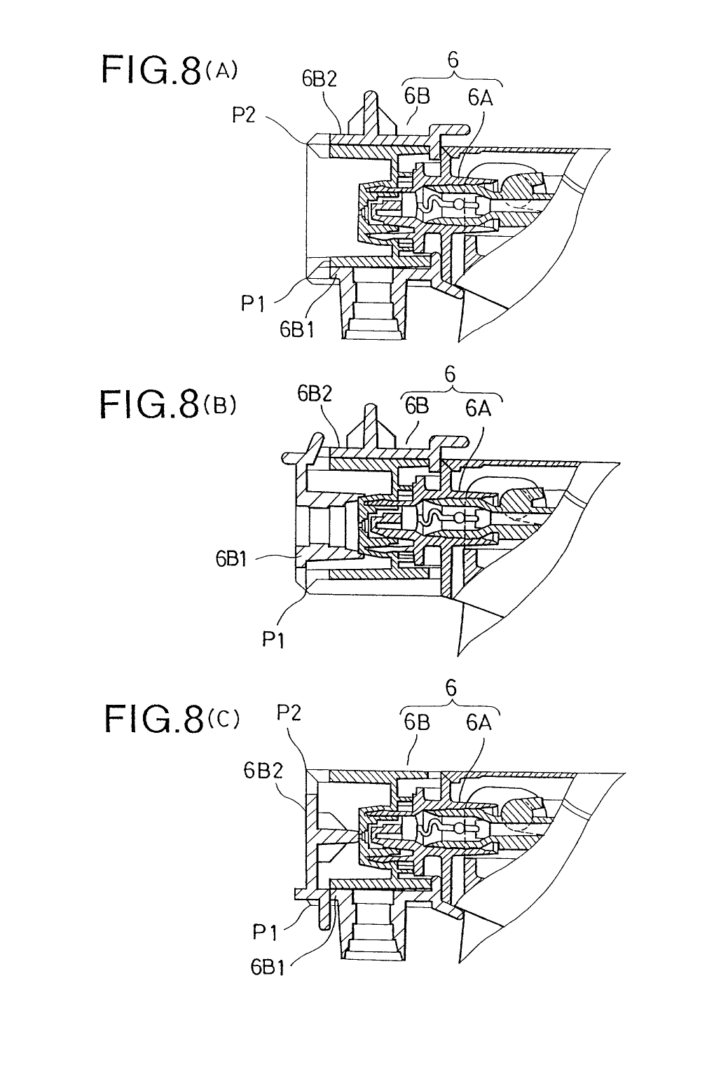

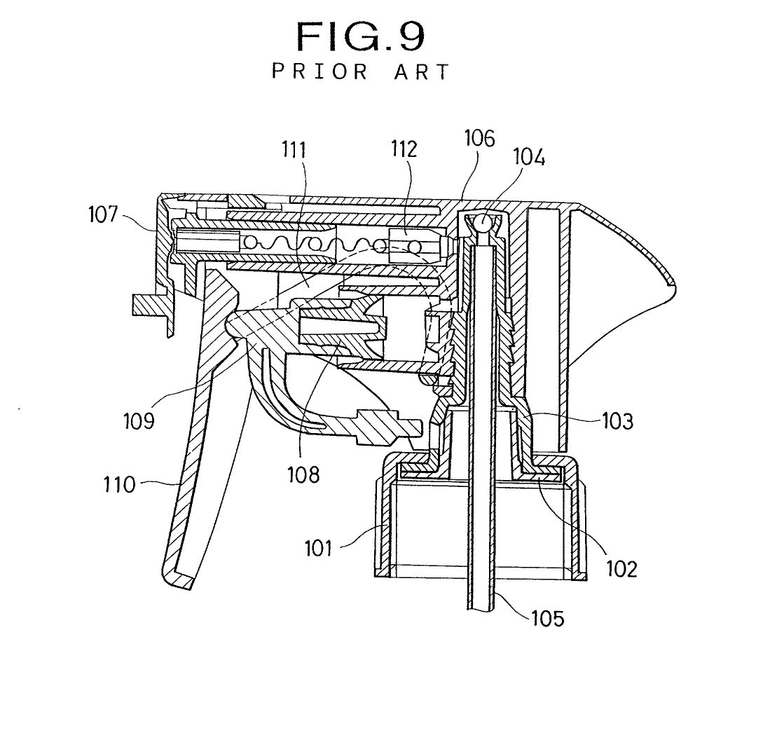

Third Embodiment (FIGS. 8(A) to 8(C)):

FIGS. 8(A) to 8(C) are sectional views showing the construction of a trigger spray according to the third embodiment of the invention.

The construction of the third embodiment is the same as that of the first embodiment except a nozzle as set forth hereunder.

In the third embodiment, a nozzle 6 comprises a nozzle base 6A and a two-way nozzle cap 6B wherein the two-way nozzle cap 6B is attached to the nozzle base 6A by the engagement therebetween.

The two-way nozzle cap 6B comprises a foaming cover member 6B1, and a closable cover member 6B2. The foaming cover member 6B1 and the closable cover member 6B2 are connected to a body of the two-way nozzle cap 6B by way of a thin thickness portion P1 serving as a hinge, wherein either of the foaming cover members 6B1 and the closable cover member 6B2 are appropriately selected and set to an injecting port.

That is, when the foaming cover member 6B1 is set to the injection port, liquid can be injected in a foaming shape while when the foaming cover member 6B1 is not set to the injection port, liquid can be injected in an ordinary spray shape.

FIG. 8(A) shows a case where liquid in is injected in an ordinary spray, wherein the closable cover member 6B2 and the foaming cover members 6B1 are temporarily fixed to the upper and lower sides of the two-way nozzle cap 6B.

FIG. 8(B) shows a case where liquid in is injected in a foaming shape, wherein the foaming cover member 6B1 is set to the injection port, and the closable cover member 6B2 is temporarily fixed to the upper side of the two-way nozzle cap 6B.

FIG. 8(C) shows a case where the closable cover member 6B2 closes the injection port and the foaming cover member 6B1 is temporarily fixed to the lower side of the two-way nozzle cap 6B.

With the provision of the two-way nozzle cap 6B, it is very convenient that liquid can be injected in a foaming shape or an ordinary spray shape (normally).

In the third embodiment of the invention, the number of the components of the trigger spray also becomes nine because of the increase of the two way nozzle cap, namely, it increases by one component compared with the number of those of the first embodiment but decreases compared with the number of those of the conventional trigger spray, so that the trigger spray of the third embodiment of the invention is excellent in the number of steps of assembling process of the components, reduction of a trouble of the trigger spray and liquid-tightness of the trigger spray. Still further, since the two way nozzle cap is also formed of polyolefine based resin, it can be recycled so that the trigger spray can cope with an environmental problem.

Although the invention has been described in detail with reference to the first, second and third embodiments, it is not limited to these embodiments, and it is needless to say that the invention can be modified variously to the extent not to depart from the gist of the invention.

Although the nozzle 6 is integrated with the cover 5 and the trigger 2 and the spring 3 are also integrated with each other according to the first and second embodiments, it is needless to say both or one of the foregoing two integration of these components can be employed.

Shapes of the foregoing components are not limited to those in the first and second embodiments, they may be of any shape if they can achieve the function of the trigger spray of the invention.

According to the invention as set forth above, the number of steps of assembly of the trigger spray of this type is much decreased, and hence productivity is improved.

Since the number of components of the trigger spray is reduced, liquid-tightness becomes improved and the trigger spray is less troubled compared with the conventional trigger spray. Still further, all the components of the trigger spray are formed of polyolefine based resin, they can be recycled so that the trigger spray can cope with an environmental problem.

What is claimed is:

1. A trigger spray for injecting liquid in a container through a nozzle by pulling a trigger comprising;
a cap attached to an opening of the container;
a base body supported by and fixed to the cap and having a first valve case, a secondary valve case, a cylinder in which a piston slides;
a trigger movably mounted on the base body and connected to the piston for pressing the piston to compress liquid in the cylinder;
a spring mounted between the trigger and the base body for elastically supporting the trigger relative to the base body;
a cover and the nozzle engaged in and fixed to the base body;
a primary valve inserted into the first valve case and a tube mounted therein; and
a secondary valve inserted into the secondary valve case and positioned between the nozzle and the secondary valve case.

2. The trigger spray according to claim 1, wherein the nozzle is integrated with and connected to the cover by way of a thin thickness portion 4A serving as a hinge.

3. The trigger spray according to claim 1, wherein the spring is integrated with the trigger.

4. The trigger spray according to claim 1, wherein the nozzle is integrated with and connected to the cover by way of a thin thickness portion serving as a hinge, and the spring is integrated with the trigger.

5. The trigger spray according to claim 1, wherein the nozzle comprises a nozzle base and a nozzle cap which is engaged with the nozzle base to be freely turned about the nozzle base.

6. The trigger spray according to claim 1, wherein the base body is sealed by an inner wall surface and an upper wall surface of the opening of the container body.

7. The trigger spray according to claim 1, wherein the nozzle comprises a nozzle base 6A and a two-way nozzle cap which is attached to the nozzle base, and the two way nozzle cap comprises a forming cover member and which can be selectively set and a closable cover member.

8. The trigger spray according to claim 1, wherein the cover is engaged with and connected to the base body at two spots.

9. The trigger spray according to claim 2, wherein the cover and the nozzle are formed of a polyolefine based resin, and integrated with each other.

10. The trigger spray according to claim 3, wherein the trigger and the spring are formed of a polyolefine based resin, and integrated with each other.

11. A spray container provided with the trigger sprays set forth in claim 1.
